(19) United States
(12) Patent Application Publication
(10) Pub. No.: US 2022/0295406 A1
(43) Pub. Date: Sep. 15, 2022

(54) BASE STATION, TERMINAL, COMMUNICATION SYSTEM, AND CONTROL METHOD

(71) Applicant: SHARP KABUSHIKI KAISHA, Sakai City, Osaka (JP)

(72) Inventors: KATSUTOSHI ISHIKURA, Sakai City, Osaka (JP); ATSUSHI YAMAZAKI, Sakai City, Osaka (JP); YUHSUKE TAKAGI, Sakai City, Osaka (JP); HIDEYUKI NAKANISHI, Sakai City, Osaka (JP); RYOKI HINATA, Sakai City, Osaka (JP)

(21) Appl. No.: 17/638,768

(22) PCT Filed: Mar. 2, 2021
(86) PCT No.: PCT/JP2021/007817

§ 371 Date: Feb. 25, 2022

(30) Foreign Application Priority Data
Mar. 23, 2020 (JP) 2020-051090

(51) Int. Cl. H04W 52/02; H04W 76/30

(52) U.S. Cl. CPC H04W 52/0235; H04W 52/0274; H04W 76/30

(57) ABSTRACT

To reduce power consumption of a terminal. A base station including a generator that generates control information on controlling a power source of a communicator in a terminal that executes a wireless communication in a first communication method and a second communication method, the communicator being for executing the wireless communication in the second communication method, and a transmitter that transmits the control information to the terminal that controls the power source of the communicator based on the control information.

### TECHNICAL FIELD

The present invention relates to a base station, a terminal, a communication system, and a control method.

The present application claims priority based on Japanese Patent Application No. 2020-051090 filed on Mar. 23, 2020 in Japan, and the contents thereof are incorporated herein by reference.

### BACKGROUND ART

Patent Document 1 describes an art for realizing a standby operation that accords to characteristics of a terminal device.

Non-Patent Document 1 describes an operation of a standby state of a terminal (UE: User Equipment) that corresponds to a 5G (Fifth-generation mobile communication system) which operates in an SA (Stand alone) mode.

### CITATION LIST

### Patent Literature

[Patent Document 1] Japanese Unexamined Patent Application Publication No. 2008-61015

### Non-Patent Literature

[Non-Patent Document 1] 3GPP TS 38.304, “User Equipment (UE) procedures in Idle mode”, 2017 March

### SUMMARY OF THE INVENTION

### Problems to be Solved by the Invention

According to the Non-Patent Document 1, at the time of the standby state, an optimum NR (New Radio) cell has to be periodically detected. Due to this, even when a terminal is in the standby state, a power source of a communicator and the like related to the NR (NR-related part) is always on. At least, the terminal turns on the power source of the NR-related part at the timing of detecting the cell of the NR.

Operation modes of the 5G network include an NSA (Non-Stand Alone) mode and an SA mode. The NSA mode has a mode of controlling the NR by using the LTE. In the NSA mode above, the terminal transmits and receives any control information to and from the LTE base station, and also transmits and receives any data to and from each of the LTE base station and the NR base station. The SA mode is a mode in which the NR operates alone. In the SA mode, the terminal transmits and receives the control information and data to and from the NR base station. The terminal that corresponds to both the NSA mode and the SA mode keeps the power source of the NR-related part turned on at the time of the standby. When the terminal is to be used in a district where the 5G network is operated in the NSA mode which does not correspond to the SA mode, the power source of the NR-related part is turned on even though it is not necessary to turn on the power source of the NR-related part at the time of the standby. Due to this, a standby current is unnecessarily consumed.

It is an object of an aspect of the present invention to reduce power consumption of a terminal.

### Solution to Problem

A base station according to an aspect of the present invention includes a generator that generates control information on controlling a power source of a communicator in a terminal that executes a wireless communication in a first communication method and a second communication method, the communicator being for executing the wireless communication in the second communication method; and a transmitter that transmits the control information to the terminal that controls the power source of the communicator based on the control information.

A terminal according to an aspect of the present invention includes a first communicator that executes a wireless communication in a first communication method; a second communicator that executes a wireless communication in a second communication method; and a power source controller that controls a power source of the second communicator based on control information that is received from a base station at the first communicator or the second communicator and that is on controlling the power source of the second communicator.

A communication system according to an aspect of the present invention includes a terminal; and a base station, wherein the terminal includes: a first communicator that executes a wireless communication in a first communication method, a second communicator that executes a wireless communication in a second communication method, and a power source controller that controls a power source of the second communicator based on control information that is received from a base station at the first communicator or the second communicator and that is on controlling the power source of the second communicator, and wherein base station includes: a generator that generates the control information, and a transmitter that transmits the control information to the terminal.

A control method of a base station according to an aspect of the present invention includes processes of generating control information on controlling a power source of a communicator in a terminal that executes a wireless communication in a first communication method and a second communication method, the communicator being for executing the wireless communication in the second communication method; and transmitting the control information to the terminal that controls the power source of the communicator based on the control information.

### BRIEF DESCRIPTION OF DRAWINGS

FIG. 1 is an example of a configuration diagram of a communication system according to a first embodiment.

FIG. 2 is an example of a configuration diagram of an LTE base station according to the first embodiment.

FIG. 3 is an example of a configuration diagram of a terminal according to the first embodiment.

FIG. 4 is an example of a flowchart of a control process at the time of a standby of the terminal according to the first embodiment.

FIG. 5 is a modification of the configuration diagram of the terminal according to the first embodiment.

FIG. 6 is an example of a configuration diagram of a communication system according to a second embodiment.

FIG. 7 is an example of a configuration diagram of an LTE base station according to the second embodiment.

FIG. 8 is an example of a configuration diagram of an NR base station according to the second embodiment.

FIG. 9 is an example of a sequence diagram of a control process in an NSA mode of the communication system according to the second embodiment.

FIG. 10 is an example of a sequence diagram of a control process in an SA mode of the communication system according to the second embodiment.

### MODE FOR CARRYING OUT THE INVENTION

The following is description of embodiments with reference to the drawings. Concerning the drawings, the same sign is given to the same or equivalent element, and duplicate explanations are to be omitted.

### First Embodiment

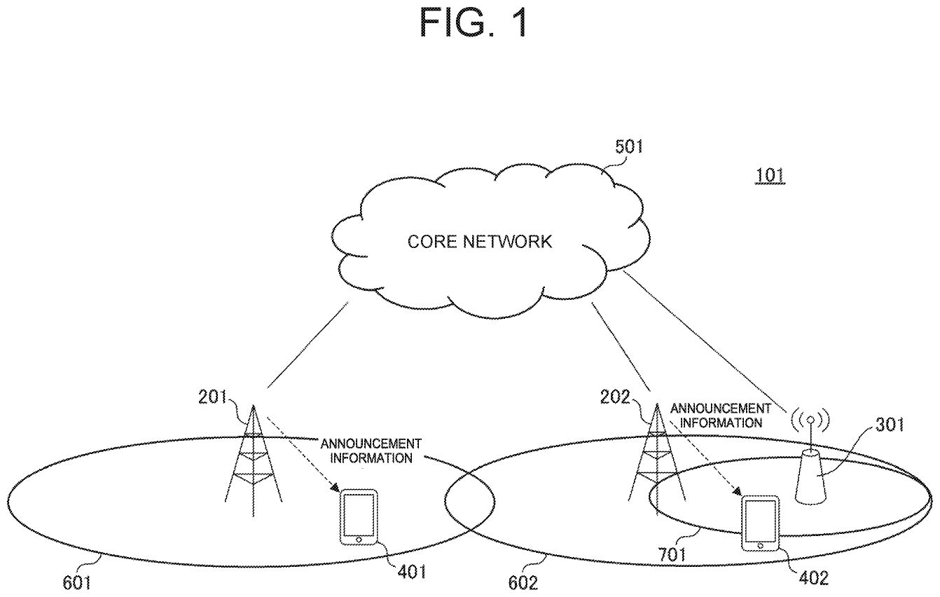

FIG. 1 is an example of a configuration diagram of a communication system according to a first embodiment.

A communication system 101 has LTE base stations 201, 202, an NR base station 301, terminals 401, 402, and a core network 501.

By an LTE (Long Term Evolution), the LTE base station 201 communicates with the terminal 401 in a cell 601 which is an area where the LTE base station 201 can make a communication. The LTE is an example of a first communication method. To the terminal 401, the LTE base station 201 transmits announcement information including any information of the LTE base station 201.

By the LTE, the LTE base station 202 communicates with the terminal 402 in a cell 602 which is an area where the LTE base station 202 can make a communication. The LTE base station 202 transmits the announcement information to the terminal 402.

By a 5G NR (New Radio) (hereinafter denoted by NR), the NR base station 301 communicates with a terminal in a cell 701 which is an area where the NR base station 301 can make a communication. The NR base station 301 is set in the cell 602. The NR is a radio system of a fifth-generation mobile communication system. The NR is an example of a second communication method.

The terminals 401 and 402 are communicatable by the LTE and the NR. The terminals 401 and 402 are communication terminals, such as smartphones, tablets, or laptops, for example. In FIG. 1, the terminal 401 is in the cell 601 and communicates with the LTE base station 201 by the LTE. Further, based on any announcement information received from the LTE base station 201, the terminal 401 controls a power source of the NR-related part in the terminal 401. In FIG. 1, the terminal 402 is in the cell 602, and communicates with the LTE base station 202 by the LTE. Further, based on any announcement information received from the LTE base station 202, the terminal 402 controls a power source the NR-related part in the terminal 402.

The core network 501 is a backbone network, for example, a network that controls a mobile network. The core network 501 is connected to the LTE base stations 201, 202, and the NR base station 301, and the above are communicatable with each other. It is so configured that, between the base stations (the LTE base station 201 and the LTE base station 202, the LTE base station 202 and the NR base station 301, and the like) are directly connected, and the base stations can directly communicate with each other without going through the core network.

Further, the configuration of the communication system described above is an example, and the number and arrangement of each of the LTE base stations. NR base stations, and terminals are not limited to the configuration described above.

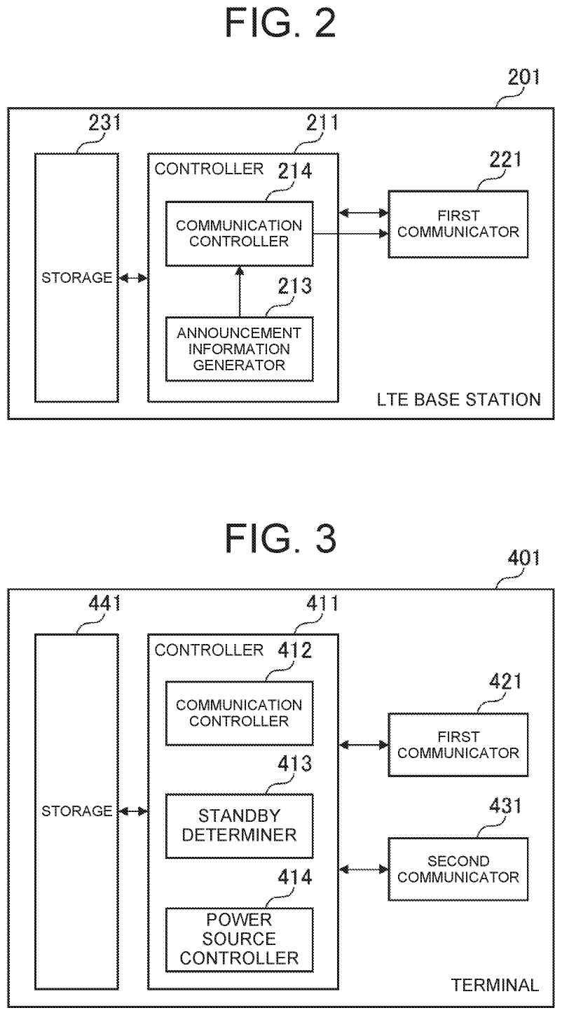

FIG. 2 is an example of a configuration diagram of the LTE base station according to the first embodiment.

Herein, the configuration of the LTE base station 201 is to be described. Further, the configuration of the LTE base station 202 is similar to the configuration of the LTE base station 201, and therefore detailed description thereof is to be omitted.

The LTE base station 201 has a controller 211, a first communicator 221, and a storage 231. Further, via a communicator (not shown), the LTE base station 201 is connected to the core network 501, any other LTE base station and any other NR base station, and the above are communicatable with each other.

The controller 211 has an announcement information generator 213 and a communication controller 214.

The announcement information generator (generator) 213 generates the announcement information including any information necessary for a communication between the terminal 401 and the LTE base station 201, and outputs the announcement information to the communication controller 214. Via the first communicator 221, the announcement information is transmitted to the terminal 401 in the cell 601 which is the area where the LTE base station 201 can make a communication. The announcement information includes, for example, a PLMN (Public Land Mobile Network) for identifying an operator, a band number for showing a frequency, and a Cell ID for selecting the base station. Further, the announcement information includes any area information which shows whether or not a NR base station is present in the cell of the own base station. The area information is, for example, a 5G indicator in 5G (parameter value of upper Layer Instruction of SIB2). When the NR base station is present in the cell of the own base station, the 5G indicator is “1”, and when no NR base station is present in the cell of the own base station, the 5G indicator is “0”. For example, the storage 231 stores area information showing whether or not the NR base station is present in the cell of the own base station, and the announcement information generator 213 refers to the area information and generates the announcement information including the area information.

For example, since no NR base station is present in the cell 601, the 5G indicator of the announcement information transmitted by the LTE base station 201 is “0”. Further, for example, since the NR base station 301 is present in the cell 602, the 5G indicator of the announcement information transmitted by the LTE base station 202 is “1”.

The communication controller 214 transmits the in which was generated by the announcement information generator 213, via the first communicator 221 to the terminal 401 in the cell 601 which is the area where the LTE base station 201 can make a communication. The announcement information is periodically transmitted from the LTE base station 201, regardless of whether or not the terminal 401 is present in the cell 601. The communication controller 214 processes any received data received from the first communicator 221 and any transmitted data to be transmitted from the first communicator 221, and executes various controls related to the communication of the LTE base station 201, such as carrier frequency control of the first communicator 221.

The first communicator 221 communicates, by the LTE, with the terminal in the cell. 601 which is the area where the LTE base station 201 can make a communication. Specifically, for example, as shown in FIG. 1, the first communicator 221 communicates, by the LTE, with the terminal 401 in the cell 601, and transmits the announcement information to the terminal 401 under the control by the communication controller 214. The first communicator 221 is an example of a transmitter.

The storage 231 stores any program, any data, and the like used by the LTE base station 201. The storage 231 stores, for example, any area information showing whether or not the NR base station is present in the cell 601 which is the area where the LTE base station 201 can make a communication. The area information is transmitted, for example, from the core network 501 to the LTE base station 201, and the LTE base station 201 stores the received area information in the storage 231. The storage 231 is, for example, a storage device such as a magnetic disk device or a flash memory.

FIG. 3 is an example of a configuration diagram of the terminal of the first embodiment.

The terminal 401 has a controller 411, a first communicator 421, a second communicator 431, and a storage 441.

The controller 411 has a communication controller 412, a standby determiner 413, and a power source controller 414.

The communication controller 412 processes any received data received from the first communicator 421 or the second communicator 431, and any transmitted data to be transmitted from the first communicator 421 or the second communicator 431, and executes various controls related to the communication of the terminal 401, such as carrier frequency control of the first communicator 421 and the second communicator 431.

Based on the information received from the LTE base stations 201, 202 or the NR base station 301, the standby determiner 413 determines whether to stand by by the LTE (first communicator 421) alone or by any of the LTE (first communicator 421) and the Nil (second communicator 431). Further, when the standby determiner 413 determines to stand by by the LTE alone, the communication controller 412 stands by by the LTE alone. Further, when the standby determiner 413 determines to stand by in any of a plurality of communication methods (or frequency bands), the communication controller 412 stands by in the communication method (or frequency bands) of the best cell among the cells of the plurality of communication methods (or frequency bands). For example, when the standby determiner 413 determines to stand by by any of the LTE and the NR, the communication controller 412 stands by in the communication method of the best cell among the cells of the LTE and the NR detected by the cell search. Specifically, for example, when the standby determiner 413 determines to stand by by any of the LTE and the NR, the communication controller 412 stands by in the communication method of the cell (the best cell) of the signal, that has the highest reception level, among the signals received from each of the cells of the LTE and the NR.

The power source controller 414 controls the power source of the second communicator 431 (power source on or power source off), based on the standby determiner 413's determination result that is based on the information received from the LTE base stations 201, 202 or the NR base station 310. For example, when the standby determiner 413 determines to stand by by the LTE (first communicator 421) alone, the power source controller 414 turns off the power source of the second communicator 431.

The first communicator 421 communicates, by the LTE, with the LTE base station that corresponds to the cell where the terminal 401 is present. For example, as shown in MG. 1, the first communicator 421 of the terminal 401 present in the cell 601 communicates, by the LTE, with the LTE base station 201.

The second communicator 431 communicates, by the NR, with the NR base station that corresponds to the cell where the terminal 401 is present. For example, in FIG. 1, when the terminal 401 is present in the cell 701, the second communicator 431 of the terminal 401 communicates, by the NR, with the NR base station 301. The storage 441 stores any program, any data and the like used by the terminal 401. The storage 441 is, for example, a storage device such as a magnetic disk device or a flash memory.

Since the configuration of the terminal 402 is similar to the configuration of the terminal 401, any detailed description thereof is to be omitted.

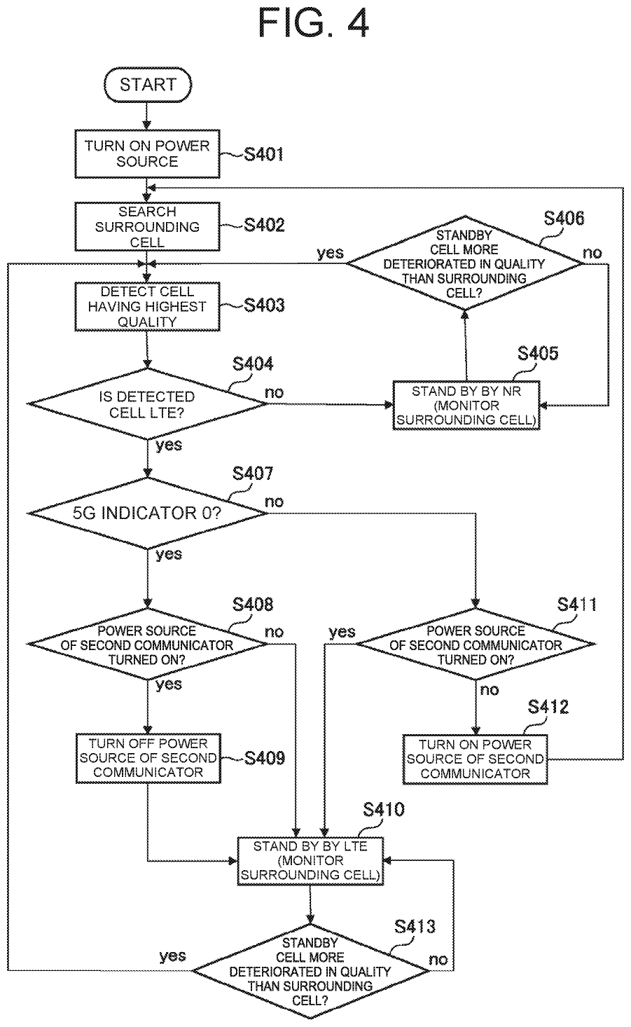

FIG. 4 is an example of a flowchart of a control process at the time of the standby of the terminal according to the first embodiment. FIG. 4 describes the control process of the terminal 401 at the time of the standby. Further, the control process at the time of the standby of the terminal 402 is the same as the control process of the terminal 401 at the time of the standby. Further, the LTE base stations 201 and 202 each transmit the announcement information as described in FIG. 2.

In step S401, a user's operation turns on the power source of the terminal 401, and the power source controller 414 turns on the power sources of the first communicator 421 and the second communicator 431.

In step S402, the communication controller 412 executes a cell search. (surrounding cell search) to search for a base station around the terminal 401, and receives a signal from the cell in which the terminal 401 is positioned (in detail, the LTE base station or the NR base station which corresponds to the cell).

In step S403, the communication controller 412 detects the cell having the highest quality. Specifically, for example, the communication controller 412, by the surrounding cell search, detects the cell of the signal, that has the highest reception level, among the signals received from each cell.

In step S404, the communication controller 412 determines whether the cell detected in step S403 is LTE or not. When it is determined that the cell is the LTE, the control proceeds to step S407, whereas when it is determined that the cell is not the LTE (that is, the cell is NR), the control proceeds to step S405.

The cell being the LTE shows that the base station that uses the above cell as a communication range (a base station corresponding to the cell) is the LTE base station. Further, the cell being the NR shows that the base station that uses the above cell as a communication range is the NR base station. It is possible to determine, from the signal received in step S402, whether the cell is the LTE or the NR.

In step S405, the communication controller 412 stands by by the NR for the cell, which was detected in step S403 as a standby cell, and also monitors a surrounding cell. Monitoring the surrounding cell, specifically, means to receive the standby cell and any cell, other than the standby cell, around the terminal 401 (in detail, the LTE base station or NR base station which corresponds to the cell), and to monitor the received signal.

In step S406, the communication controller 412 determines whether or not the standby cell is more deteriorated in quality than the surrounding cell. Specifically, for example, the communication controller 412 determines whether or not the reception level of the signal received from the standby cell is lower than the reception level of the signal received from the cell other than the standby cell. When the reception level of the signal received from the standby cell is lower than the reception level of the signal received from the cell other than the standby cell, the communication controller 412 determines that the standby cell is more deteriorated in quality than the surrounding cell.

When it is determined that the standby cell is more deteriorated in quality than the surrounding cell (step S406: Yes), the control returns to step S403. When it is determined that the standby cell is not more deteriorated in quality than the surrounding cell (step S406: N), the control returns to step S405.

In step S407, the first communicator 421 receives the announcement information from the LTE base station that corresponds to the standby cell, and the standby determiner 413 determines whether or not the 5G indicator (the parameter value of the upper Layer Instruction of SIB2) included in the announcement information is 0. When it is determined that the 5G indicator is 0, the standby determiner 413 determines to stand by by the LTE (first communicator 421) alone, and the control proceeds to step S408. When it is determined that the 5G indicator is not 0 (that is, 1), the standby determiner 413 determines to stand by by any of the LTE (first communicator 421) and the NR (second communicator 431), and the control proceeds to step S411.

In step S408, the power source controller 414 determines whether or not the power source of the second communicator 431 is turned on. When it is determined that the power source of the second communicator is turned on (step S408: Yes), the control proceeds to step S409, whereas when it is determined that the power source of the second communicator is not turned on (step S408: No), the control proceeds to step S410.

In step S409, the power source controller 414 turns off the power source of the second communicator 431. In this way, when the 5G indicator is 0, no NR base station is present in the standby cell, therefore, it is determined to stand by by the LTE (first communicator 421) alone, and the power source controller 414, due to no need for executing the standby by the NR, turns off the power source of the second communicator 431. This reduces the power consumption of the terminal 401 at the time of the standby.

In step S410, the communication controller 412, since the cell detected in step S403 and having the highest quality is the LTE, determines to stand by by the LTE, and stands by by the LTE for the cell, which was detected in step S403, as a standby cell, and also monitors the surrounding cell.

In step S411, the power source controller 414 determines whether or not the power source of the second communicator 431 is turned on. When it is determined that the power source of the second communicator is turned on (step S411: Yes), the control proceeds to step S410, whereas when it is determined that the power source of the second communicator is not turned on (step S411: No), the control proceeds to step S412. As described above, when the 5G indicator is “1” (step S407: No), and the power source of the second communicator 431 is turned on (step S411: Yes), the control proceeds to step S410 and the communication controller 412 stands by by the LTE; however, since the NR base station is present around the terminal 401, the power source controller 414 does not turn off the power source of the second communicator 431 and leaves the power source of the second communicator 431 turned on. This means that it is so made that, both the LTE cell and the NR cell can be monitored.

In step S412, the power source controller 414 turns on the power source of the second communicator 431.

In step S413, the communication controller 412 determines whether or not the standby cell is more deteriorated in quality than the surrounding cell. Specifically, for example, the communication controller 412 determines whether or not the reception level of the signal received from the standby cell is lower than the reception level of the signal received from the cell other than the standby cell. When the reception level of the signal received from the standby cell is lower than the reception level of the signal received from the cell other than the standby cell, the communication controller 412 determines that the standby cell is more deteriorated in quality than the surrounding cell.

When it is determined that the standby cell is more deteriorated in quality than the surrounding cell (step S413: Yes), the control proceeds to step S403. When it is determined that the standby cell is not more deteriorated in quality than the surrounding cell (step S413: No), the control returns to step S410.

According to the first embodiment, when the standby by the NR is not required, turning off the power source of the second communicator that makes a communication by the NR can reduce the power consumption of the terminal at the time of the standby.

(First Modification of the First Embodiment)

The 5G indicator of the first embodiment described above indicates whether or not the NR base station is present in the cell of the LTE base station that is reporting it, and it is uncertain whether or not the above NR base station corresponds to the SA mode when the NR base station is present. When the NR base station does not correspond to the SA mode, the terminal cannot be connected even the cell of the above NR base station stands by; therefore there is no need for standing by at the above NR base station. Then, in the first modification, the LTE base station transmits information showing whether or not the NR base station that corresponds to the SA mode is present in the cell of the above LTE base station.

Specifically, in the first modification of the first embodiment, the announcement information generator 213 of the LTE base station 201 includes, in the announcement information, the area information showing whether or not the NR base station is present in the cell of the own base station (for example, the 5G indicator) and additionally the SA correspondence information.

When the NR base station is present in the cell of own base station, the SA correspondence information shows whether or not the NR base station corresponds to the SA mode. The SA correspondence information is, for example, “SA mode correspondence” which shows that the NR base station corresponds to the SA mode, or “SA mode non-correspondence” which shows that the NR base station does not correspond to the SA mode. The SA correspondence information is preliminarily stored in the storage 231, for example, and may be appropriately updated by the core network 501. The SA correspondence information is an example of the control information on the power source control of the second communicator (communicator) that executes a wireless communication by the NR (second communication method). The SA mode is an example of a communication mode where the base station uses the NR (the second communication method) alone. The LTE base station. 201 outputs the announcement information including the SA correspondence information.

Herein, the control process of the terminal 401 at the time of the standby is to be described. For example, the terminal 401 of the first modification executes the control process of the flowchart shown in FIG. 4, but executes the following process in place of the above process in step S407. Any process other than step S407 is as described in FIG. 4.

In the first modification of the first embodiment, in step S407 of FIG. 4, the standby determiner 413 determines whether or not the SA correspondence information included in the announcement information is “SA mode non-correspondence”. When it is determined that the SA correspondence information is “SA mode non-correspondence”, the standby determiner 413 determines to stand by by the LTE (first communicator 421) alone, and the control proceeds to step S408. When the SA correspondence information is not “SA mode non-correspondence” (that is, the SA correspondence information is “SA mode correspondence”), the standby determiner 413 determines to stand by by any of the LTE (the first communicator 421) and the NR (the second communicator 431), and the control proceeds to step S411.

When the SA correspondence information is “SA mode non-correspondence” as described above, it is determined to stand by by the LTE (first communicator 421) alone, and when the second communicator 431 is turned on (step S408: Yes), the power source of the second communicator 431 is turned off (step S409).

According to the first modification of the first embodiment, when the NR base station does not correspond to the SA mode, the terminal, by turning off the power source of the second communicator 431 that communicates by the NIB at the time of the standby, can reduce the power consumption at the time of the standby.

(Second Modification of the First Embodiment)

In a second modification of the first embodiment, the announcement information generator 213 of the LTE base station 201 includes, in the 5G indicator or the announcement information, the presence or absence of the NR base station in the cell of the own base station, and the frequency information showing the frequency band to which the NR base station corresponds (communicatable). The presence or absence of the NR base station in the cell of the own base station, and the frequency information showing the frequency band to which the NR base station corresponds are preliminarily stored, for example, in the storage 231, and may be appropriately updated by the core network 501. The frequency information is an example of the control information on the power source control of the second communicator (communicator) that executes the wireless communication by the NR (second communication method). The LTE base station 201 outputs the announcement information including the frequency information.

The NR base station 301 corresponds to both of a milli-wave frequency band of 24.25 GHz to 52.6 GHz and a frequency band below 6 GHz that is referred to as sub6, or to the sub6 only.

For example, when (i) there is an NR base station in the cell of the own base station, and the above NR base station has the milli-wave thus corresponding to the sub6, the frequency information becomes “NR milli-wave correspondence”. (ii) When there is an NR base station in the cell of the own base station and the above NR base station corresponds to only the sub6, the frequency information becomes “NR available (no milli-wave correspondence)”. (iii) When there is no NR base station in the cell of the own base station, the frequency information becomes “NR unavailable”.

Further, the LTE base station 202 executes the process same as that of the LTE base station 201.

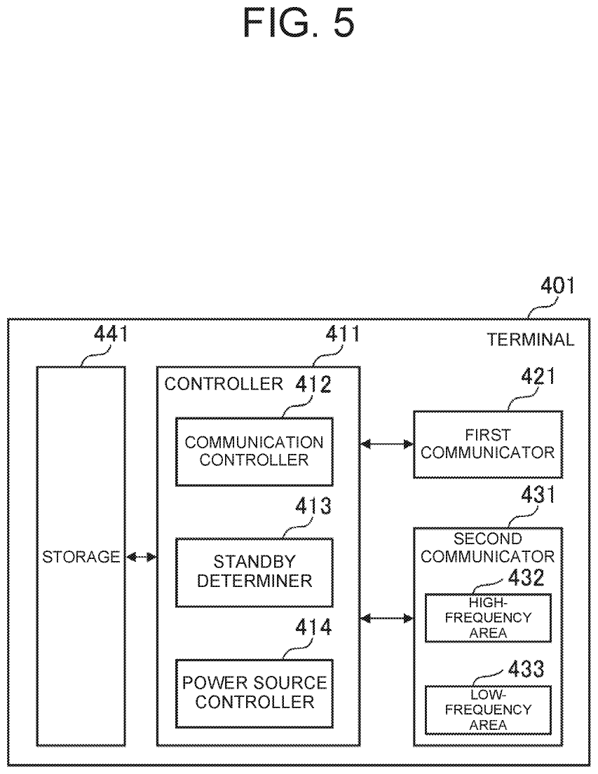

FIG. 5 is a modification of the configuration diagram of the terminal according to the first embodiment.

The terminal 401 has the controller 411, the first communicator 421, the second communicator 431, and the storage 441. The controller 411 has the communication controller 412, the standby determiner 413, and the power source controller 414. Any description of the communication controller 412, the first communicator 421, and the storage 441 is to be omitted since they have been described in FIG. 3.

The second communicator 431 communicates, by the NR, with the NR base station that corresponds to the cell in which the terminal 401 is present. The second communicator 431 has a high-frequency area 432 and a low-frequency area 433.

In the NR, the high-frequency area 432 makes a communication that uses the milli-wave frequency band of 24.25 GHz to 52.6 GHz.

In the NR, the low-frequency area 433 communicates in a frequency band lower than the milli-wave. Specifically, the low frequency area 433 makes a communication using a frequency band of less than 6 GHz that is referred to as sub6.

The standby determiner 413, based on the frequency information received from the LTE base station, determines whether to stand by by the LTE (first communicator 421) alone, or by any of the LTE (first communicator 421) and the NR (second communicator 431). Further, when standing by by the NR (second communicator 431), the standby determiner 413 determines whether to stand by, in the second communicator 431, by the sub6 (low-frequency area 433) alone, or by any of the milli-wave (high-frequency area 432) and the sub6 (low-frequency area 433).

Specifically, for example, when the frequency information is (i) “NR milli-wave correspondence”, the standby determiner 413, when standing by by the NR (the second communicator 431), determines to stand by, in the NR (the second communicator 431), by any of the milli-wave (high-frequency area 432) and the sub6 (low-frequency area 433).

Specifically; for example, when the frequency information is (ii) “NR available (no milli-wave correspondence)”, the standby determiner 413, when standing by by the NR (second communicator 431), determines to stand by; in the NR (the second communicator 431), by the sub6 (low-frequency area 433) alone.

Specifically, for example, when the frequency information is (iii) “NR unavailable”, the power source controller 414 determines to stand by by the LTE (first communicator 421) alone.

Based on the standby determiner 413's determination result which is based on the frequency information received from the LTE base station, the power source controller 414 controls the power source of each of the high-frequency area 432 the low-frequency area 433 of the second communicator 431.

Specifically, for example, when the determination result is (i) “when standing by by the NR (second communicator 431), stand by, in the NR (the second communicator 431), by any of the milli-wave (high-frequency area 432) and the sub6 (low-frequency area 433)” (when the frequency information is “NR milli-wave correspondence”), the power source controller 414 turns on the power sources of both of the high-frequency area 432 and the low-frequency area 433 of the second communicator 431.

Specifically, for example, when the determination result is (ii) “when standing by by the NR (second communicator 431), stand by in the NR the second communicator 431), by the sub6 (low-frequency area 433) alone” (when the frequency information is “NR available (no milli-wave correspondence)”), the power source controller 414 turns off the power source of the high-frequency area 432 of the second communicator 431 and turns on the power source of the low-frequency area 433 of the second communicator 431.

Specifically, for example, when the determination result is (iii) “stand by by the LTE (first communicator 421) alone” (when the frequency information is “NR unavailable”), the power source controller 414 turns off the power sources of both of the high-frequency area 432 and the low-frequency area 433 of the second communicator 431.

Further, when the determination result is any of (i) to (iii) above, the power source of the first communicator 421 is turned on.

According to the second modification of the first embodiment, when the NR base station does not correspond to the milli-wave, turning off the power source of the high-frequency area that communicates by the wave in the terminal can carefully reduce the power consumption at the time of the standby.

Further, the LTE base station may transmit, as frequency information, whether or not the NR in the NR base station can correspond to each band. In that case, the second communicator 431 of the terminal 401 has a plurality of processors which respectively communicate by the corresponding NR bands, and the power source controller 414 turns off the power source of the processor in the second communicator 431 that makes the communication which uses the band to which the NR base station does not correspond as shown by the frequency information. This makes it possible to carefully reduce, at the time of the terminal's standby, the power consumption for each band to which the NR base station corresponds.

(Third Modification of the First Embodiment)

As described in the first embodiment above, when controlling the power source of the second communicator 431 of the terminal 401 based on the area information (5G indicator), there is a case where the power source of the second communicator 431 is turned on or off whenever the terminal 401 moves between the cells, and frequent repetitions of turning on and off of the power source of the second communicator 431 burden the terminal 401.

Then, for example, as shown in FIG. 1, when no NR base station is present in the range of the cell 601 of the LTE base station 201, but the NR base station 301 is present in the adjacent cell 602, in view of a case where the terminal 401 moves from the cell 601 to the cell 602 and then moves to the cell 701, the terminal 401 preliminarily stands by by the NR when the terminal 401 is present in the cell 601 as well.

In the third modification of the first embodiment, the announcement information generator 213 of the LTE base station 201 includes, in the announcement information, any corresponding area information showing that the cell of the own base station is an NSA mode corresponding area or an SA mode corresponding area. The NSA mode corresponding area is, for example, a cell where no NR base station corresponding to the SA mode is present in the own base station cell and the adjacent cell. The SA mode corresponding area is, for example, a cell where an NR base station corresponding to the SA mode is present in the own base station cell and the adjacent cell. The above definitions of the NSA mode corresponding area and of the SA mode corresponding area are each an example; for example, a telecommunication carrier can appropriately set a certain cell in the NSA mode corresponding area or the SA mode corresponding area. The corresponding area information is preliminarily stored, for example, in the storage 231, and may be appropriately updated by the core network 501. The corresponding area information is an example of the control information on the power source control of the second communicator (communicator) that executes the wireless communication by the NR (second communication method).

The standby determiner 413 of the terminal 401 of the third embodiment determines whether or not the corresponding area information included in the announcement information shows the NSA mode corresponding area. When it is determined that the corresponding area information shows the NSA mode corresponding area, the standby determiner 413 determines to stand by by the LTE (first communicator 421) alone, and the power source controller 414 turns off the power source of the second communicator 431. When it is determined that the corresponding area information does not show the NSA mode corresponding area (that is, when the corresponding area information shows the SA mode corresponding area), the standby determiner 413 determines to stand by by any of the LTE (first communicator 421) and the NR (second communicator 431), and the power source controller 414 turns on the power source of the second communicator 431. Regardless of when the area information shows either the NSA mode corresponding area or the SA mode corresponding area, the power source of the first communicator 421 is turned on.

According to the third modification of the first embodiment, it is possible to prevent frequent repetition of turning on and off of the power source of the second communicator 431 for each movement between cells and also to reduce the power consumption of the terminal 401 at the time of the standby.

Further, the announcement information generator 213 of the LTE base station 201 may include, in the announcement information, a power source instruction showing whether to turn on or off the power source of the second communicator 431. The power source instruction is, for example, “power source on” showing turning on of the power source of the second communicator 431, or “power source off” showing turning off of the power source of the second communicator 431. The power source instruction is preliminarily stored, for example, in the storage 231, and may be appropriately updated by the core network 501. The power source instruction is an example of the control information on the power source control of the second communicator (communicator) that executes the wireless communication by the NR (second communication method).

The standby determiner 413 of the terminal 401 determines whether or not the power source instruction included in the announcement information is “power source off”. When it is determined that the power source instruction is “power source off”, the standby determiner 413 determines to stand by by the LTE (first communicator 421) alone, and the power source controller 414 turns off the power source of the second communicator 431. When it is determined that the power source instruction is not “power source off” (that is, the power source instruction is “power source on”), the standby determiner 413 determines to stand by by any of the LTE (the first communicator 421) and the NR (the second communication method), and the power source controller 414 turns on the power source of the second communicator 431. Further, regardless of when the power source instruction is either “power source on” or “power source off”, the power source of the first communicator 421 is turned on. In this way, the LTE base station 201 transmits the power source instruction showing whether to turn on or off the power source of the second communicator 431, controls the power source of the second communicator 431 of the terminal 401, making it possible to reduce the power consumption.

### Second Embodiment

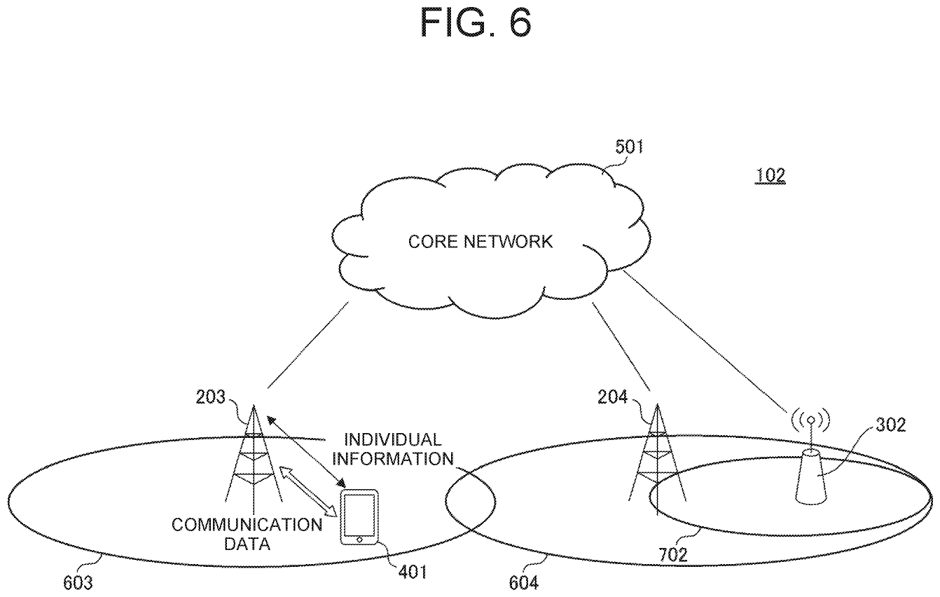

FIG. 6 is an example of a configuration diagram of a communication system for a second embodiment.

A communication system 102 has LTE base stations 203, 204, a NR base station 302, the terminal 401, and the core network 501.

By the LTE (Long Term Evolution), the LTE base station 203 communicates with the terminal 401 in a cell 603 which is in an area where the LTE base station 203 can make a communication. The LTE base station 203 transmits any individual information to the terminal 401 by a control-directed channel of the LTE, and transmits the communication data to the terminal 401 by a data-directed channel of the LTE. The individual information will be described afterward.

By the LTE, the LTE base station 204 communicates with a terminal (not shown) in a cell 604 which is an area where the LTE base station 204 can make a communication. Further, the LTE base station 204 transmits the individual information by the control-directed channel of the LTE, and transmits the communication data by the data-directed channel of the LTE.

By the 5G NR (New Radio) (hereinafter denoted by NR), the NR base station 302 communicates with a terminal in a cell 702 which is an area where the NR base station 302 can make a communication. The NR, base station 302 is set in the cell 604.

The terminal 401 is a terminal that can make a communication by the LTE and the NR. The terminal 401 is a communication terminal, such as a smartphone, tablet, or laptop, for example. The configuration of the terminal 401 has been described in FIG. 4, so detailed description thereof is to be omitted. In FIG. 6, the terminal 401 is in the cell 603, and communicates with the LTE base station 203 by the LTE. Further, based on the individual information received from the LTE base station 203, the terminal 401 controls the power source of the second communicator 431 in the terminal 401.

The core network 501 is a backbone network, for example, a network that controls a mobile network. The core network 501 is connected to the LTE base stations 203, 204, and the NR base station 302, and the above are communicatable with each other.

Further, it is so configured that, between the base stations (the LTE base station 203 and the LTE base station 204, LTE base station 204 and the NR base station 302, and the like) are directly connected, and the base stations directly communicate with each other without going through the core network.

Further, the configuration of the communication system described above is an example, and the number and arrangement of each of the LTE base stations, NR base stations, and terminals are not limited to the configuration described above.

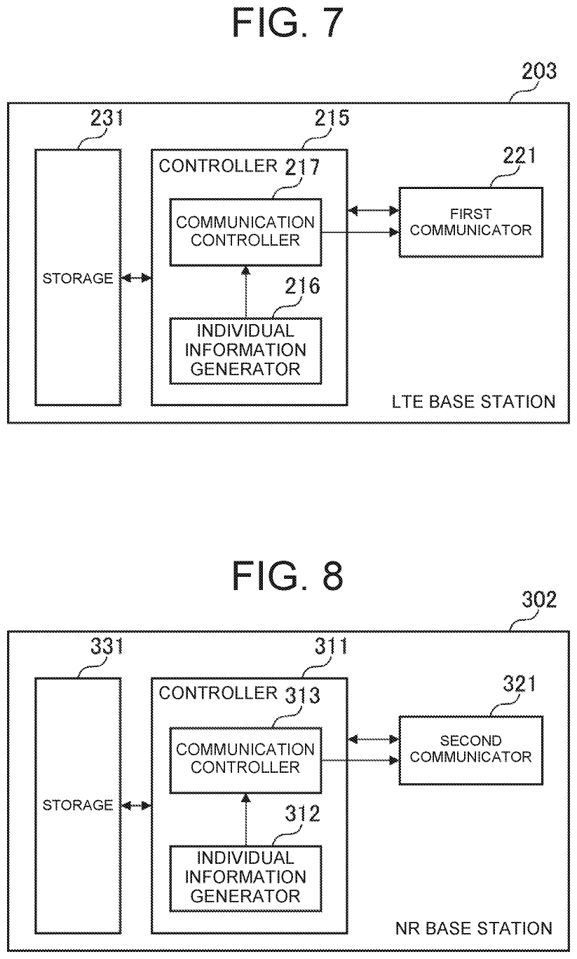

FIG. 7 is an example of a configuration diagram of an LTE base station according to the second embodiment.

Herein, the configuration of the LTE base station 203 is to be described. Further, the configuration of the LTE base station 204 is similar to the configuration of the LTE base station 203, and therefore detailed description thereof is to be omitted.

The LTE base station 203 has a controller 215, the first communicator 221, and the storage 231. Further, via a communicator (not shown), the LTE base station. 203 is connected to the core network 501, any other LTE base station, and any other NR base station, and the above are communicatable with each other.

The controller 215 has an individual information generator 216 and a communication controller 217.

The individual information generator 213 generates the individual information on the power source control of the second communicator 431 (communicator) that executes the wireless communication by the NR (second communication method) of the terminal 401. The individual information is, for example, an instruction of how to stand by of the terminal 401, and is “NR power source off” showing not standing by by the NR, or “NR power source on” showing standing by by the NR. For example, the storage 231 stores the individual information, and the individual information generator 213 generates the individual information by referring to the individual information in the storage 231. The individual information is an example of the control information on the power source control of the second communicator (communicator) that executes the wireless communication by the NR (second communication method) of the terminal.

By the control-directed channel, the communication controller 217 transmits, from the first communicator 221, a connection release message (RRC Connection Release) that is to be transmitted at the end of the communication with the terminal 401 and that is caused to include the individual information generated by the individual information generator 213. Further, the communication controller 217 processes any received data received from the first communicator 221 and any transmitted data to be transmitted from the first communicator 221, and executes various controls related to the communication of the LTE base station 203, such as carrier frequency control of the first communicator 221. Using the first communicator 221, the communication controller 217 transmits and receives the communication data by the data-directed channel.

The first communicator 221 communicates, by the LTE, with the terminal in the cell 603 which is an area where the LTE base station 203 can make a communication. Specifically, for example, as shown in FIG. 6, the first communicator 221 communicates, by the LTE, with the terminal 401 in the cell 603, and, at the end of the communication, transmits, to the terminal 401, the communication release message including the individual information. The first communicator 221 is an example of a transmitter.

The storage 231 stores any program, any data, and the like used by the LTE base station 203. The storage 231 stores, for example, the individual information. The individual information is transmitted, for example, from the core network 501 to the LTE base station 203, and the LTE base station 203 stores the received individual information in the storage 231. For example, when no NR base station is present in the cell of the own base station, or when the NR base station is present in the cell of the own base station but the NR base station does not correspond to the SA mode (when making a communication in the NSA mode), the terminal does not need to stand by by the NR; therefore, the individual information becomes “NR power source off”. The storage 231 is, for example, a storage device such as a magnetic disk device or a flash memory.

FIG. 8 is an example of a configuration diagram of the NR base station according to the second embodiment. Further, the NR base station in FIG. 8 is an example of the configuration diagram that corresponds to the SA mode.

The NR base station 302 has a controller 311, a second communicator 321, and a storage 331. Further, via a communicator (not shown), the NR base station 302 is connected to the core network 501, any other LTE base station, and any other NR base station, and the above are communicatable with each other.

The controller 311 has an individual information generator 312 and a communication controller 313.

The individual information generator 312 generates the individual information on the power source control of the second communicator 431 (communicator) that executes the wireless communication by the NR (the second communication method) of the terminal 401. The individual information is, for example, an instruction of how to stand by of the terminal 401, and is “NR power source off” showing not standing by by the NR, or “NR, power source on” showing standing by by the NR. For example, the storage 331 stores the individual information, and the individual information generator 312 generates the individual information by referring to the individual information in the storage 331. The individual information is an example of the control information on the power source control of the second communicator (communicator) that executes the wireless communication by the NR (second communication method) of the terminal.

The communication controller 313 transmits a communication release message (RRC Connection Release) that is to be transmitted at the end of the communication with the terminal 401 and that is caused to include the individual information generated by the individual information generator 312. Further, the communication controller 313 processes any received data received from the second communicator 321 and any transmitted data to be transmitted from the second communicator 321, and executes various controls related to the communication of the NR base station 301, such as carrier frequency control of the second communicator 321.

The second communicator 321 communicates, by the NR, with the terminal in the cell 604 which is an area where the NR base station 302 can make a communication. Specifically, for example, the second communicator 221 communicates, by the NR, with the terminal in the cell 604, and, at the end of the communication, transmits, to the terminal, the communication release message including the individual information. The second communicator 321 is an example of the transmitter.

The storage 331 stores any program, any data, and the like used by the LTE base station 203. The storage 231 stores, for example, the individual information. The individual information is transmitted, for example, from the core network 501 to the NR base station 302, and the NR base station 302 stores the received individual information in the storage 331. For example, the NR base station 302 corresponds to the SA mode, and the individual information ordinarily becomes “NR power source on”. However, when the terminal is made to stand by by the LTE despite a base station corresponding to the SA mode being present in the vicinity on the network side, the individual information may be set to “NR power source off”. The storage 331 is, for example, a storage device such as a magnetic disk device or a flash memory.

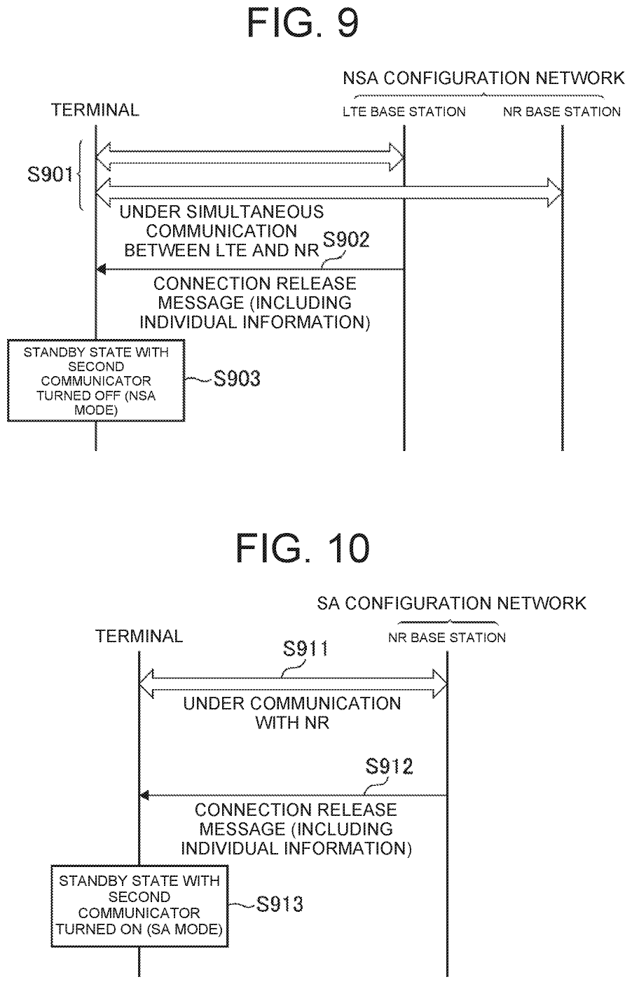

FIG. 9 is an example of a sequence diagram of a control process in the NSA mode of the communication system according to the second embodiment.

Description will be made of a case where, for example, in FIG. 6, the terminal 401 is present in the cell 702, the NR base station 302 does not correspond to the SA mode, and the communication is executed in the NSA mode. Further, it is assumed that the terminal 401 has been already connected with the LTE base station 204 and the NR base station 302.

The terminal 401 transmits and receives the control information to and from the LTE base station 204, and also transmits and receives the data to and from each of the LTE base station 204 and the NR base station 302 (step S901).

At the end of the connecting between the terminal 401 and the LTE base station. 204, the individual information generator 216 of the LTE base station 204 generates the individual information, and the communication controller 217 transmits, to the terminal 401, the connection release message (RRC Connection Release) including the individual information (step S902). For example, when the communication is executed in the NSA mode, there is no need to stand by by the NR, so the individual information is “NR power source off” which shows not standing by by the NR.

The communication controller 412 of the terminal 401 receives the connection release message, and the power source controller 414, since the individual information included in the received connection release message “NR power source off”, turns off the power source of the second communicator 431, and the communication controller 412, with the first communicator 421, stands by by the LTE alone (step S903). In detail, the standby determiner 413 determines whether the individual information included in the connection release message is “NR, power source off”. As described above, in the NSA mode, the individual information is “NR power source off”. When it is determined that the individual information is “NR power source off”, the standby determiner 413 determines to stand by by the LTE (first communicator 421) alone, and the power source controller 414 turns off the power source of the second communicator 431 and the communication controller 412, with the first communicator 421, stands by by the LTE.

FIG. 10 is an example of a sequence diagram of a control process in the SA mode of the communication system according to the second embodiment.

For example, description will be made of a case where, for example, in FIG. 6, the terminal 401 is present in the cell 702, the NR base station 302 corresponds to the SA mode, and the communication is executed in the SA mode. Further, it is assumed that the terminal 401 has been connected with the NR base station 302.

By the NR, the terminal 401 transmits and receives the control information to and from the NR base station 302 (step S911).

At the end of the connecting between the terminal 401 and the NR base station 302, the individual information generator 312 of the NR base station 302 generates the individual information, and the communication controller 313 transmits, to the terminal 401, the connection release message (RRC Connection Release) including the individual information (step S912). For example, in the present embodiment, since the operation is being done in the SA mode and it is necessary to stand by by the NR, the individual information is “NR power source on” which shows standing by by the NR.

The communication controller 412 of the terminal 401 receives the connection release message, and the power source controller 414, since the individual information included in the received connection release message is “NR power source on”, turns on the power source of the second communicator 431, and the communication controller 412, with the second communicator 431, stands by by the NR (step S913). In detail, the standby determiner 413 determines whether the individual information included in the connection release message is “NR power source off”. As described above, in the SA mode, the individual information is “NR power source on”. When it is determined that the individual information is not “NR power source off” (that is, the individual information is “NR power source on”), the standby determiner 413 determines to stand by with the second communicator 431, and the power source controller 414 turns on the power source of the second communicator 431 and the communication controller 412 stands by, with the second communicator 431, by the NR.

Further, when it is desired that the terminal 401 should stand by by the LTE in the SA mode as well, the individual information generator 312 of the NR base station 302 may set the individual information to “NR power source off”.

Even if the power source of the second communicator 431 is turned off during the standby based on the individual information, in the case that the NR base station is present in the vicinity once the LTE communication starts thereby to change from the standby state to the LTE connection state; the NR search instruction from the network allows the power source controller 414 of the terminal 401 to turn on the power source of the second communicator 431, making it possible to allow the communication controller 412 to start searching the NR and making a communication by the NR.

Although the individual information was included in the connection release message transmitted from the base station at the end of the communication between the terminal and the base station, the individual information is not limited thereto and may be transmitted, for example, at the start of the communication between the terminal and the base station.

Further, in the first place, it is the NR base station corresponding to the SA mode that executes the control of the individual information by the NR; due to this, it is acceptable to use as the existing individual information, without including “NR power source off” or “NR power source on” instruction in the individual information. In this case, it can be so made that, when the NR base station ends the communication with the existing connection release message, the terminal, while leaving the NR power source turned on, stands by by any of the LTE and the NR.

According to the second embodiment, when the standby by the NR is not required, turning off the power source of the second communicator that makes a communication by the NR can reduce the power consumption of the terminal at the time of the standby

(First Modification of the Second Embodiment)

In the communication system 102, the position of the terminal 401 is managed as a unit of a set of adjacent cells called a tracking area. When the terminal 401 straddles the tracking area (the area that manages the terminal position) at the time of the standby movement, an updating process of the tracking area is executed. The first modification of the second embodiment includes the individual information in the connection release message transmitted from the base station (LTE base station or NR base station), in the updating process of the tracking area. The individual information (“NR power source on” or “NR power source off”) is determined by the core network 501, for example, for each tracking area, and is stored in the storages 231 of the LTE base stations 203, 204 or the storage 331 of the NR base station 302.

Similar to the second embodiment described above, the terminal 401, based on the individual information, controls the power source of the second communicator 431.

The first modification of the second embodiment can execute the power source control of the second communicator 431 that appropriately stands by every time the terminal straddles the tracking area, and that makes a communication by the NR.

(Second Modification of the Second Embodiment)

in a second modification of the second embodiment, when the terminal 401 receives the connection release message from the LTE base station 203, the power source controller 414 turns off the power source of the second communicator 431 and the communication controller 412, with the first communicator 421, stands by by the LTE alone. When the terminal 401 receives the connection release message from the NR base station 302, the power source controller 414 turns on the power source of the second communicator 431 and the communication controller 412 stands by by any one of the LTE (first communicator 421) and the NR (the second communicator 431). In this way, the power source controller 414 controls the power source of the second communicator 431 according to the type of the base station from which the connection release message is transmitted.

Further, the LTE base station may transmit, as individual information, whether or not the NR in the NR base station can correspond to each band. In that case, the second communicator 431 of the terminal 401 has a plurality of processors which respectively communicate by the corresponding NR bands, and the power source controller 414 turns off the power source of the processor in the second communicator 431 that makes the communication which uses the band to which the NR base station does not correspond as shown by the individual information. For example, when it is shown that the individual information does not correspond to a band n257 in the NR, the power source controller 414 turns off the power source of the processor that makes the communication by the band n257 in the second communicator 431. This makes it possible to carefully reduce, at the time of the terminal's standby, the power consumption for each band to which the NR base station corresponds.

Whether the individual information is “NR power source off” or “NR power source on” may be set, for example, as follows.

Regarding the individual information, for example, according to whether the NR base station corresponding to the SA mode is present in a certain area centered on the base station that transmits the individual information, the individual information may be set by the core network 501. In this case, when the NR base station corresponding to the SA mode is present in the certain area centered on the base station that transmits the individual information, the individual information transmitted from the base station becomes “NR power source on”. When no NR base station corresponding to the SA mode is present in the certain area centered on the base station that transmits the individual information, the individual information transmitted from the base station becomes “NR power source off”.

Regarding the individual information, for example, according to whether the NR base station corresponding to the SA mode is present the cell of the base station that transmits the individual information, the individual information may be set by the core network 501. In this case, when the NR base station corresponding to the SA mode is present in the cell of the base station that transmits the individual information, the individual information transmitted from the base station becomes “NR power source on”. When no NR base station corresponding to the SA mode is present in the cell of the base station that transmits the individual information, the individual information transmitted from the base station becomes “NR power source off”.

Regarding the individual information, for example, according to whether the NR base station corresponding to the SA mode is present in the tracking area that includes the cell of the base station that transmits the individual information, the individual information may be set by the core network 501. In this case, when the NR base station corresponding to the SA mode is present in the tracking area that includes the cell of the base station that transmits the individual information, the individual information transmitted from the base station becomes “NR power source on”. When no NR base station corresponding to the SA mode is present in the tracking area that includes the cell of the base station that transmits the individual information, the individual information transmitted from the base station becomes “NR power source off”.

Further, regarding the individual information, for example, according to whether the base station that transmits the individual information is the LTE base station or the NR base station, the individual information may be set by the core network 501. In this case, when the base station that transmits the individual information is the NR base station, the individual information transmitted from the NR base station becomes “NR power source on”. When the base station that transmits the individual information is the LTE base station, the individual information transmitted from the LTE base station becomes “NR power source off”.

In this case, there is no need to specifically include the “NR power source on” or “NR, power source off” instruction in the individual information, and any existing individual information is sufficient. At this time, for the terminal to end the communication from the LTE, when the NR power source of the terminal is turned off and the communication is ended from the NR, the NR power source may be kept turned on.

Further, the individual information may be generated in view of, for example, the mobile state of the terminal. Even if no NR base station corresponding to the SA mode is present in the cell of the LTE base station that transmits the individual information, when it is determined that the mobile speed of the terminal is fast (more than or equal to a threshold value), the individual information generator 215 sets, as “NR power source on”, the individual information to be transmitted from the relevant LTE base station to the terminal. The mobile speed of the terminal is determined, for example, by the core network 501 or the individual information generator 216.

Further, it may be so made that only when turning on of the power source of the second communicator 431 of the terminal 401 is required, the individual information generator 312 of the NR base station 302 generates the individual information, and the communication controller 313 transmits, to the terminal 401, the connection release message (RRC Connection Release) including the individual information. In this case, the power source controller 414 of the terminal 401 turns on the power source of the second communicator 431 in the ease of the individual information being included in the connection release message, and the communication controller 412 stands by by either the LTE (first communicator 421) or the NR (second communicator 431). The power source controller 414 turns off the power source of the second communicator 431 in the case of the individual information being not included in the connection release message, and the communication controller 412 stands by by the LTE (first communicator 421) alone.

Further, although the instruction of “NR power source on” or, “NR power source off” is included in the individual information, “NR power source on” may be replaced by “SA mode correspondence” and “NR power source off” may be replaced by “NSA mode correspondence”.

### Example of Realization by Software

The LTE base stations 201, 203, the NR base station 302, and the control block of the terminal 401 (in particular, controllers 211, 215, 311, 411) may be realized by a logic circuit (hardware) formed in an integrated circuit (IC (Integrated Circuit) chip) or the like, and also may be realized by software using a CPU (Central Processing Unit). In the latter case, the LTE base stations 201, 203, the NR base station 302, and terminal 401 are provided with a CPU that executes an instruction of a program that is software to realize each function, a ROM or storage device where the above program and various data are readably recorded by the computer (or CPU) (these are referred to as “recording medium”), and RAM, etc. to deploy the above program. Then, the computer (or CPU) reads and executes the above program from the above recording medium, thereby accomplishing the object of the present invention. Examples of the recording medium include “non-transitory tangible media” such as a tape, a disk, a card, a semiconductor memory, and a programmable logic circuit. Further, the above program may be supplied to the above computer via any transmitting medium that is capable of transmitting the program.

Further, the present invention is not limited to the above embodiments but can be modified, and the above configuration can be replaced by a substantially identical configuration, a configuration that exerts the same effect, or a configuration that can accomplish the same object.

According to the above embodiments, the power source of the second communicator 431 that communicates by the NR is controlled, but the power source of the first communicator 421 that communicates by the LTE may also be controlled. Further, when the first communicator 421 is used for the standby, any RAT (Radio Access Technology), such as W-CDMA (Wideband Code Division Multiple Access), other than the NR may be used for the further standby.

1. A base station comprising:
a generator that generates control information on controlling a power source of a communicator in a terminal that executes a wireless communication in a first communication method and a second communication method, the communicator being for executing the wireless communication in the second communication method; and
a transmitter that transmits the control information to the terminal that controls the power source of the communicator based on the control information.

2. The base station according to claim 1, wherein the control information shows whether or not another base station present in a communication range of the base station corresponds to a communication mode where the second communication method is used alone.

3. The base station according to claim 1, wherein the control information shows whether another base station present in a communication range of the base station corresponds to a communication that uses a predetermined frequency in the second communication method.

4. The base station according to claim 1, wherein the control information is an instruction to turn on or off a power source of the communicator.

5. The base station according to claim 1, wherein the control information is included in a connection release message transmitted from the base station to the terminal at an end of a communication between the base station and the terminal.

6. The base station according to claim 1, wherein the first communication method is an LTE (Long Term Evolution), and the second communication method is an NR (New Radio).

7. A terminal comprising:
a first communicator that executes a wireless communication in a first communication method;
a second communicator that executes a wireless communication in a second communication method; and
a power source controller that controls a power source of the second communicator based on control information that is received from a base station at the first communicator or the second communicator and that is on controlling the power source of the second communicator.

8. A communication system comprising:
a terminal; and
a base station,
wherein the terminal includes:
a first communicator that executes a wireless communication in a first communication method,
a second communicator that executes a wireless communication in a second communication method, and
a power source controller that controls a power source of the second communicator based on control information that is received from the base station at the first communicator or the second communicator and that is on controlling the power source of the second communicator, and
wherein base station includes:
a generator that generates the control information, and
a transmitter that transmits the control information to the terminal.

9. (canceled)
